(19) United States
(12) Patent Application Publication
(10) Pub. No.: US 2023/0069832 A1
(43) Pub. Date: Mar. 9, 2023

(54) DECORATING ACCESSORY

(71) Applicant: DIY DESIGNS AND INNOVATIONS (UK) LTD, Swanley (GB)

(72) Inventor: Derek ASHBURN, Swanley (GB)

(21) Appl. No.: 17/793,400

(22) PCT Filed: Jan. 18, 2021
(86) PCT No.: PCT/GB2021/050105

§ 371 Date: Jul. 17, 2022

(30) Foreign Application Priority Data
Jan. 17, 2020 (GB) 2000725.8

(51) Int. Cl. B05C 21/00

(52) U.S. Cl. CPC B05C 21/005

(57) ABSTRACT

The present application discloses a decorating accessory 100 for protecting a surface beneath a hung door 200, the accessory 100 comprising an elongate tray 101 having a base 102 and a pair of longitudinal edges 103, 104 raised above the base 102, the tray 101 being tapered at a first end 105.

### TECHNICAL FIELD

Embodiments of the present invention described herein relate to a decorating accessory for protecting a surface when decorating a door.

### BACKGROUND TO THE INVENTION AND PRIOR ART

When painting a property, decorators and house painters often use protective materials such as sheets, cloths or newspapers to cover floors in order to protect them from splatters or drips of paint. In particular, when painting doors, use of such material can result in newspaper stuck to newly painted doors, or paint dripping down gaps in sheet coverage onto floor surfaces below. A further difficulty in painting doors is that, being hinged, they are not stationary and can easily swing from above a protected surface when the coating is applied. Because of these challenges some decorators go to the trouble of removing doors from their hinges to prevent contamination of floor surfaces.

The present invention provides a solution to the above problem.

### SUMMARY OF THE INVENTION

According to the invention there is provided a decorating accessory for protecting a surface beneath a hung door, the accessory comprising an elongate tray having a base and a pair of rims extending upwardly from the base to a pair of longitudinal edges respectively forming raised upper edges of the rims, the tray being tapered at a first end.

The invention provides advantages over current methods described above. For example, the decorating accessory conveniently protects a surface beneath a door when applying a coat of paint (or varnish, etc.). The decorating accessory is suitable for almost any door, as the size of the decorating accessory can be varied to suit a variety of door sizes and types. The decorating accessory reduces the risk of contaminants dripping onto the surface below, and can reduce and/or eliminate expensive replacement costs for carpets or tiles, for example. Furthermore, the decorating accessory allows the decorator to paint the full face of the door, including its lower extremities, by simultaneously brushing against the decorating accessory and the lowest part of the face of the door without concern for applying paint to the floor covering, as would be the case when using newspaper or fabric sheets. Further, the tapered end provides the advantage of allowing the user to use the decorating accessory for a door which cannot be fully opened due to an obstruction behind the door, for example, a wall or a piece of furniture, without having to remove the door from its hinges.

The longitudinal edges may be substantially parallel.

The base may be substantially flat.

The accessory may further comprise an inclined wall between the base and the pair of longitudinal edges.

The first end of the tray may have first, second and third end portion edges. Each of the three end portion edges may be straight and together define a trapezoid shape. Alternatively the three end portion edges may be slightly curved.

The second end portion edge may be perpendicular to the longitudinal edges.

The first and third end portion edges may be at angle of between 30 and 60 degrees to the second end portion edge, at angle of between 35 and 55 degrees to the second end portion edge, at angle of between 40 and 50 degrees to the second end portion edge and more preferably at angle of 45 degrees to the second end portion edge.

The accessory may further comprise a handle disposed at a second end of the tray.

The handle may extend between the pair of longitudinal edges. A handle enables the user to easily slide and position the decorating accessory underneath the door to be painted, as well as removing the decorating accessory after the painting has been completed.

The handle may comprise an aperture or hook. The aperture may be a loop disposed on the handle. There may be protrusions on an upper surface of the base. The aperture allows the decorating accessory to be hung on a wall when not in use, enabling easy and convenient storage.

The accessory may be made of a plastic (such as high-density polyethylene (HDPE)), a metal or of another suitable material.

According to an example there is provided a decorating accessory for protecting a surface beneath a hung door, the accessory comprising an elongate tray having a base and a pair of longitudinal edges raised above the base, the tray being tapered at a first end.

### BRIEF DESCRIPTION OF THE DRAWINGS

Embodiments of the invention will now be further described by way of example only and with reference to the accompanying drawings, wherein like reference numerals refer to like parts and wherein:

FIG. 1 is a perspective view of a decorating accessory according to an embodiment of the present invention;

FIG. 2 is a plan view of the decorating accessory of FIG. 1;

FIG. 3 is an end view of the decorating accessory of FIG. 1;

FIG. 4 is a side view of the decorating accessory of FIG. 1;

FIG. 5 is a plan view of the decorating accessory of FIG. 1 in use beneath a door;

FIG. 6 is a top isometric view of a decorating accessory according to an embodiment of the present invention;

FIG. 7 is a bottom isometric view of the decorating accessory of FIG. 6;

FIG. 8 is a plan view of the decorating accessory of FIG. 6;

FIG. 9 is a side view of the decorating accessory of FIG. 6;

FIG. 10 is a view showing detail as circled in A of FIG. 9;

FIG. 11 is a perspective view of a decorating accessory according to an embodiment of the present invention;

FIG. 12 is an end view of the decorating accessory of FIG. 11; and

FIG. 13 is a plan view of the decorating accessory of FIGS. 11 and 12 in use beneath a wide door.

### DESCRIPTION OF THE EMBODIMENTS

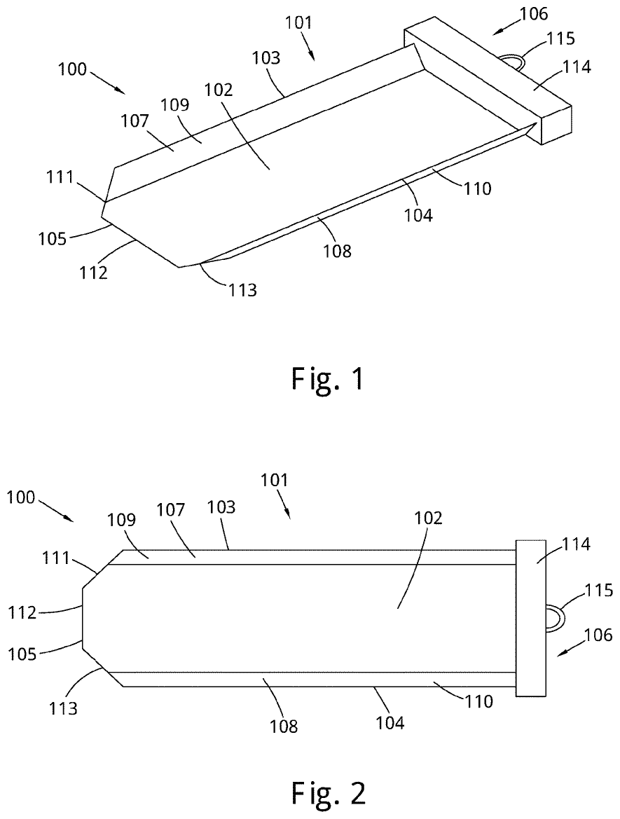

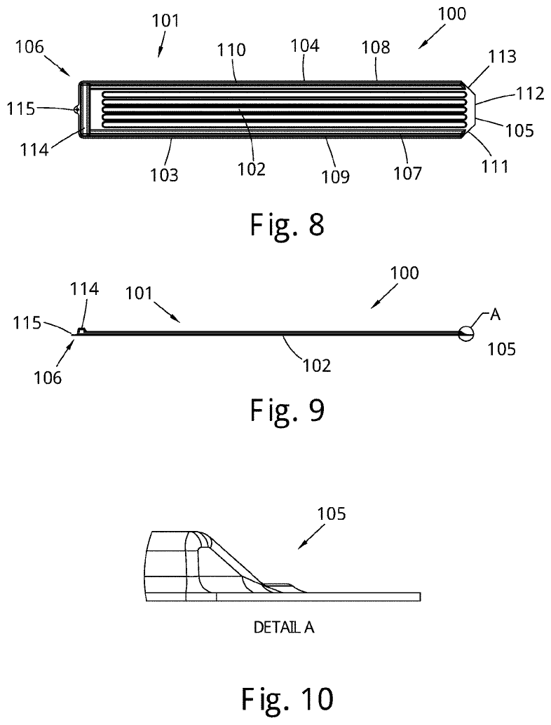

FIGS. 1-4 and 6-9 show a decorating accessory 100 according to an embodiment of the present invention. The decorating accessory 100 comprises an elongate tray 101 having a substantially flat base 102 and first 107 and second 108 upwardly projecting longitudinal rims. An upper edge of each rim 107, 108 respectively defines first 103 and second 104 longitudinal edges such that the pair of longitudinal edges 103, 104 are raised above the base 102. The longitudinal edges 103, 104 are substantially parallel to one another. The tray 101 is tapered at a first end 105, as is described in further detail below, and a handle 114 is provided at a second end 106 of the tray.

The tapered first end 105 comprises first 111, second 112 and third 113 end portion edges. The second end portion edge 112 forms part of an edge of the base 102 at the first end 105 of the tray 101 and is perpendicular to the longitudinal edges 103, 104. The first 111 and third 113 end portion edges span the end of the base 103 and the ends of the first 107 and second 108 rims respectively. These end portion edges 111, 112, 113 are straight and together define a trapezoid shape at the first end 105 of the tray 101, better shown by the plan view in FIG. 2. The first 111 and third 113 end portion edges are at an angle of 45 degrees to the second end portion edge 112 and the first 103 and second 104 longitudinal edges.

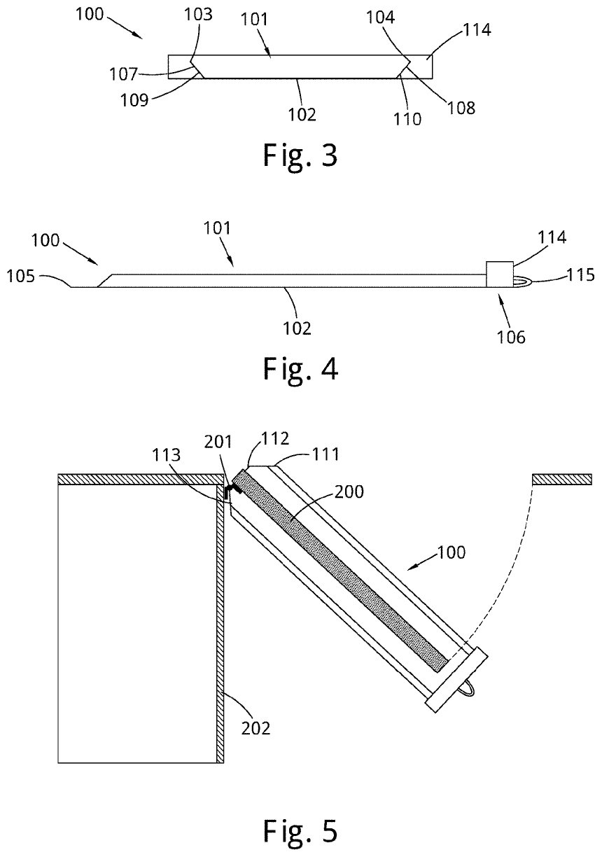

The rims 107, 108 help to prevent liquid (e.g., paint, varnish, etc.) which may drip or be spilt on to the tray 101 from making its way onto the floor beneath the door. The rims 107, 108 respectively comprise first 109 and second 110 inclined walls which extend from the base 102 of the tray 101 to the first 103 and second 104 longitudinal edges, as can be seen best in the end view of FIG. 3. The first 109 and second 110 inclined walls are inclined at an angle of 45 degrees to the plane of the base 102. The rims 107, 108 also facilitate use of a paint brush or roller to apply the coating to the door, and function as a protective guard which is elevated above the floor.

The handle 114 is attached to the second end 106 of the tray 101 to function as a gripping location, to aid the user with positioning the decorating accessory 100 beneath the door as well as subsequently retracting the decorating accessory 100 from beneath the door, without spilling any paint. The handle 114 may extend transversely between and beyond the pair of longitudinal edges 103, 104. The handle 114 may comprise a loop or hook 115, providing an aperture for hanging the decorating accessory 100. In this manner the decorating accessory 100 can be easily hung up on a nail or screw on a wall for storage when not in use.

The tapered first end 105 allows the decorating accessory 100 to be used on a door 200 which opens against an obstructing wall 202, as shown in FIG. 5. Similarly, the decorating accessory 100 can be used where furniture is positioned by the door. In such cases, access to the rear of the door is impeded, requiring the door 200 to be decorated when it is partially, and not fully, open. By having the tapered first end 105 cut away in this manner, the decorating accessory 100 can be positioned beneath the full width of the door 200 without having to remove the door 200 from its hinges 201. This allows greater coverage of protection for the floor against paint dripping and in particular when painting the lowest extremities of the faces of the door. Without the first end 105 being tapered, it is not possible to position the decorating accessory 100 beneath the whole width of the door 200 without removing the door 200 from its hinges 201. If the decorating accessory was not tapered in this manner a portion of the floor beneath the door would remain unprotected from paint splatters and drips. In this case, the user would likely have to resort to traditional methods of using newspaper or sheets to cover the additional space, or even removing the door from its hinges.

The decorating accessory 100 may be made from plastic, preferably polypropylene, or metal, preferably aluminium, or from any other suitable material. For example, the accessory may be made from cardboard. Polypropylene is light, durable and easy to clean. Wet paint can be easily wiped off polypropylene and dry paint can be easily peeled away from the surface. The easy cleaning of the decorating accessory encourages the decorating accessory to be reused on multiple occasions. Aluminium is similarly strong, durable and easy to clean. Aluminium is stronger and more durable than polypropylene.

The decorating accessory 100 is dimensioned so that it can be used with most doors. A standard UK door is 760 mm wide and 35 mm thick. The decorating accessory 100 therefore has an overall length of 830-900 mm, e.g. 860 mm, and a width of 115-125 mm, with the second end portion edge 112 having a length of 70-90 mm. The loop 115 may extend 10 mm from the end 106 of the accessory. The inventor also envisages having longer and wider versions of the decorating accessory, to accommodate larger doors, such as those used for front doors of buildings.

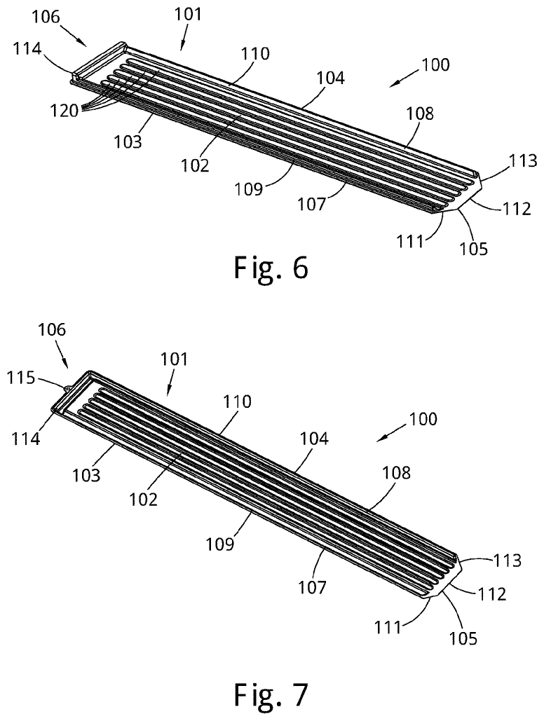

In the embodiment described with reference to FIGS. 1-5 the upper surface of the base 102 of the tray 101 is flat. In the embodiment described with reference to FIGS. 6-10 there are ribs 120 extending from the upper surface of the base, the ribs 120 running the bulk of the length of the base 102 and having a width of 5 mm. Other embodiments may have other types of protrusions on their upper surface. Such ribs/protrusions act as a buffer to distance the base 102 from the bottom of the door, so that when the bottom of the faces of the door are painted, the door will be spaced from the base 102. Such protrusions need only be of a nominal height of 0.5 or 1 mm. The protrusions may take the form of discrete points of any shape on the surface of the base 102.

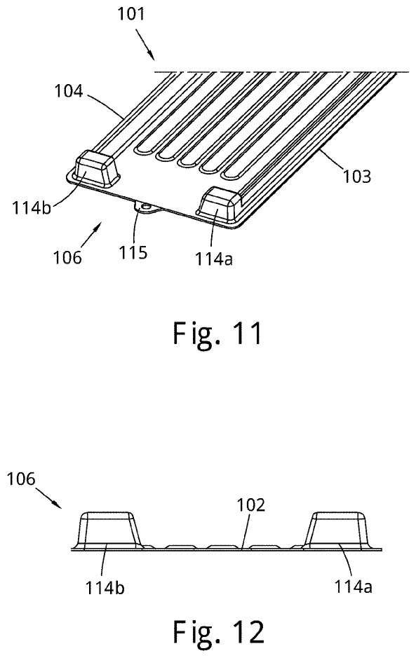

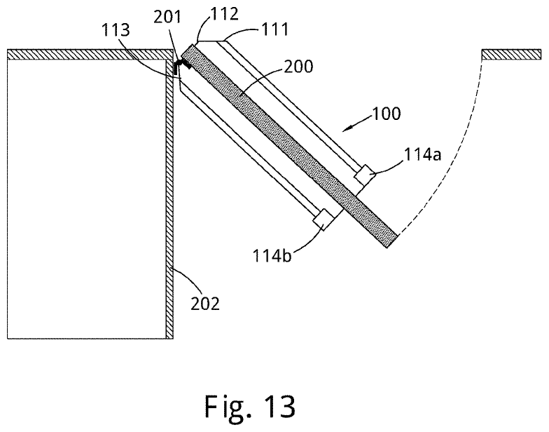

FIGS. 11-13 show an alternative handle structure to that shown in FIGS. 1, 2, and 6-8. FIGS. 11 and 12 illustrate how the handle portion 114 may comprise two distinct handle portions 114a, 114b. The advantage of this embodiment is that if a door 200 is wider than standard, as shown in FIG. 13, the decorating accessory 100 can nevertheless be positioned up to the hinge without the door abutting the handle. In use, the decorating accessory 100 can be moved outwards away from the hinge once the portion of the door nearest the hinge has been decorated. In this manner the utility of the decorating accessory 100 is not limited by the presence of the handle 114.

Various modifications whether by way of addition, deletion, or substitution of features may be made to above described embodiment to provide further embodiments, any and all of which are intended to be encompassed by the appended claims.

For example, in the embodiment described above the tapered end 105 has three straight end portion edges 111, 112, 113. In other embodiments one or more of the three edges 111, 112, 113 may be curved. In other embodiments the tapered end 105 may not have three distinct edges, but instead have a semi-circle shape, or a rounded-triangle shape, or any other suitable shape.

In the embodiment described above first 111 and third 113 end portion edges are at an angle of 45 degrees to the second end portion edge 112. In other embodiments, the first 111 and third 113 end portion edges may be at an angle of between 30 and 60 degrees to the second end portion edge 112, at an angle of between 35 and 55 degrees, or more preferably at an angle of between 40 and 50 degrees to the second end portion edge 112.

In the embodiment described above the base 102 is substantially flat with a distinct rim 107, 108. In other embodiments the base 102 may be curved, the axis of curvature being parallel to the longitudinal edges 103, 104. In this embodiment, or other embodiments, the tray 101 may not have a distinct rim 107, 108 along the longitudinal edges 103, 104.

In the embodiment described above the handle 114 comprises a hook 115 for hanging the decorating accessory 100 when it is stored. Instead of having a separate hook 115 an aperture may be formed in the handle 114 into which a nail or screw may be inserted.

In the embodiment described above the handle 114 is formed as a block. In other embodiments the handle may have a different form, as long as it assists the user with positioning and removing the decorating accessory 100 with respect to the door.

1. A decorating accessory for protecting a surface beneath a hung door, the accessory comprising:
an elongate tray having a base and a pair of rims extending upwardly from the base to a pair of longitudinal edges respectively forming raised upper edges of the rims, the tray being tapered at a first end.

2. An accessory as claimed in claim 1, wherein the longitudinal edges are substantially parallel.

3. An accessory as claimed in claim 1, wherein the base is substantially flat.

4. An accessory as claimed in claim 3, further comprising an inclined wall between the base and the pair of longitudinal edges.

5. An accessory as claimed in claim 1, wherein the first end has first, second and third end portion edges.

6. An accessory as claimed in claim 5, wherein each of the three end portion edges are straight and together define a trapezoid shape.

7. An accessory as claimed in claim 6, wherein the second end portion edge is perpendicular to the longitudinal edges.

8. An accessory as claimed in claim 7, wherein the first and third end portion edges are at angle of between 30 and 60 degrees to the second end portion edge.

9. An accessory as claimed in claim 8, wherein the first and third end portion edges are at angle of between 35 and 55 degrees to the second end portion edge.

10. An accessory as claimed in claim 9, wherein the first and third end portion edges are at angle of between 40 and 50 degrees to the second end portion edge.

11. An accessory as claimed in claim 10, wherein the first and third end portion edges are at angle of 45 degrees to the second end portion edge.

12. An accessory as claimed in claim 1, further comprising a handle disposed at a second end of the tray.

13. An accessory as claimed in claim 12, wherein the handle extends between the pair of longitudinal edges.

14. An accessory as claimed in claim 12, wherein the handle comprises an aperture.

15. An accessory as claimed in claim 14, wherein the aperture is a loop disposed on the handle.

16. An accessory as claimed in claim 1, further comprising protrusions on an upper surface of the base.

17. An accessory as claimed in claim 1, the accessory being made of a plastic or a metal.

18. An accessory as claimed in claim 12, wherein the handle comprises two distinct handle portions wherein there is a gap between the two handle portions.
